(19) United States
(12) Patent Application Publication
(10) Pub. No.: US 2012/0197870 A1
(43) Pub. Date: Aug. 2, 2012

(54) TRANSFORMING ENTITY AND RELATION DATA USING A PROXY ENGINE

(76) Inventors: Jan Simon, Prague (CZ); Jan Trcka, Revnice (CZ); Pavel Chmelicek, Prague (CZ)

(21) Appl. No.: 13/015,475

(22) Filed: Jan. 27, 2011

(51) Int. Cl. G06F 17/30

(52) U.S. Cl. 707/722; 707/759; 707/E17.005; 707/E17.017

(57) ABSTRACT

A method is provided for transforming entity and relation data using a proxy engine. A proxy data engine can intercept a virtual query directed to a data provider application on a data repository device. The proxy data engine can transform the virtual query into a native query capable of being processed by the data provider application. The virtual query can include a virtual entity-relation object not included in the native query. The proxy data engine can transform a native result into a virtual result including the virtual entity-relation object. The native result can be a response to the native query and the native result can be received by the data provider application.

### BACKGROUND

Databases can be used to store and retrieve data. Data can be retrieved through a data request called a query. A data provider or database can process the query and generate a result. The retrieved data can be selected, sorted, organized, and viewed based on the query. The result can be provided to a user in a table or a graph based on the underlying data and data structure.

Graph-structured data can be visually presented to an end user. Visualization can help users better understand the internal structure of data and can be used to navigate through the data. A way to visualize the data can be to map entities and relations of data one-to-one to a visualized graph's nodes and edges.

### BRIEF DESCRIPTION OF THE DRAWINGS

FIG. 1 is an illustrative block diagram showing a generation of a graph from a query in accordance with an example;

FIG. 2 is an illustrative block diagram showing a generation of a virtual graph from a virtual query using a proxy engine in accordance with an example;

FIG. 3 is an illustrative block diagram showing a generation of a virtual graph from a virtual query using a proxy engine in accordance with an example;

FIG. 4 is an illustrative block diagram showing a virtual result generated from a virtual query using a proxy engine in accordance with an example;

FIG. 5 is an illustration of a system using a proxy engine in accordance with an example;

FIG. 6 is an illustration of a system using a proxy engine in accordance with an example;

FIG. 7 is an illustrative diagram showing a proxy engine using transformation rules to transform a native result into a virtual result in accordance with an example; and

FIG. 8 is a flowchart illustrating a method for transforming entity and relation data using a proxy engine in accordance with an example.

### DETAILED DESCRIPTION

Alterations and further modifications of the illustrated features, and additional applications of the principles of the examples, which would occur to one skilled in the relevant art and having possession of this disclosure, are to be considered within the scope of the disclosure. The same reference numerals in different drawings represent the same element.

Data in a data repository and storage device (e.g., database) can have an internal structure that defines data objects, entities, or nodes and defines relations or edges between objects, entities, or nodes. The actual internal structure of data may not match the logical structure of the data and the relationships between data objects may not match a natural view or understanding of the data.

A visual graph structure of the internal structure of data can be helpful in understanding the internal structure of data or can be helpful in navigating through the data. Sometimes the visual graph structure of the internal data structure in the data repository may not be helpful for a user to understand the data structure, especially when the internal structure, entities, and relations have more detail than is useful for a user. To increase the understanding of the presented data to the user and improve the users overall experience in using the data, the data can be transformed from a native internal structure into a virtual visual graph structure or a virtual result. The virtual visual graph structure can more effectively present relevant data entities and data relations to a user. For example, a virtual graph may eliminate some technical details in a relationship between entities while maintaining a basic relationship between the entities.

Maintaining the native internal structure of data in a data repository device may be desirable even though a virtual visual graph structure can increase the understanding of the presented data to a user. Some reasons for maintaining the native internal structure can be for backwards compatibility of a legacy model, to allow for different user views, and to maintain the technical details of existing internal data. In the legacy situations, the use-cases of a computer system or an application can evolve and change from version to version, and users may desire a prior version to be backward compatible with a current version. Maintaining backward compatibility with a legacy model allows multiple application versions to be used with a data repository or applications based on an earlier version to be used.

Often users in a computer system can have different roles related to the data, different views of the data, or a different desired representation of the data and these differences can be helpful for users to understand the data based on their role. Some users may want to view some technical details while other users may want view other technical details. One user may want to see high level entities and relations of the model while other users may want to see detailed structures, entities, and relations. The internal data model can be rich with information and contain many extra entities and relations which are used for internal purposes but may not be helpful when displayed to a user (e.g., hidden files on a file system). Allowing a different view of the data at varying levels of abstraction may be desirable while maintaining the native internal data structure.

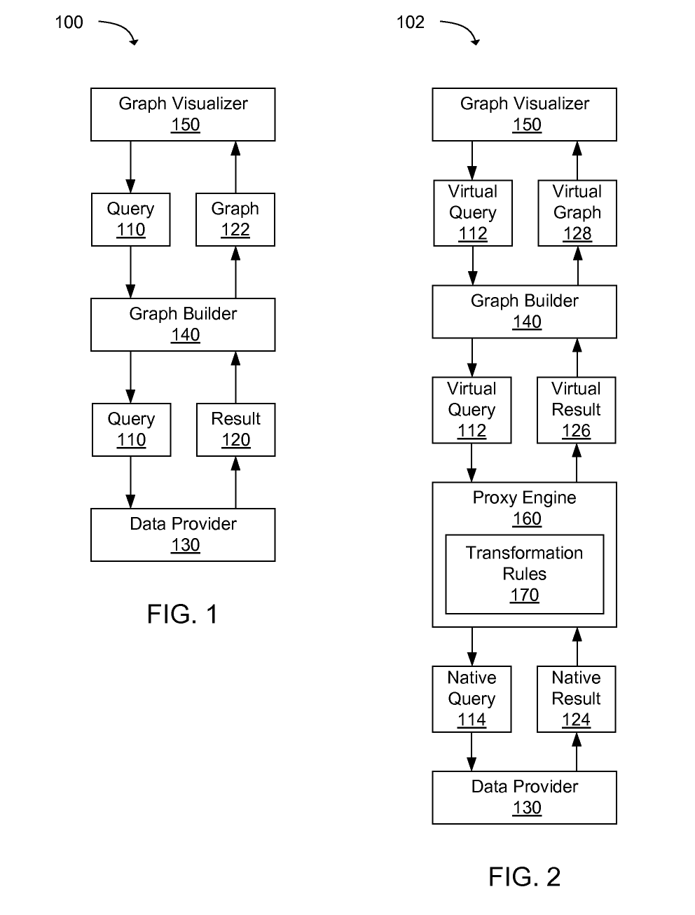

Typically in a system 100, a query 110 can be sent to a data provider 130 or data provider module and the data provider can process the query and return a result 120 or a schema, as illustrated in FIG. 1. A result can include data with entity types and relation types. A schema can include entity types, relation types, and relationships between entity types and relations types that can be presented in a graph or other visual representation. The data provider can include a data provider application that receives a query request, searches a data repository for matching data, and returns a result based on the arguments in the query. The data provider application can be a combination of a processor, memory, and programming. The programming can be database application instructions stored in memory and the instructions can run on the processor.

The query 110 may be sent from a graph visualizer 150 or graph builder 140. The graph builder may generate a graph 122 from the result 120 or schema and display the graph using a graph visualizer on a display device. The graph builder may be a component which by querying the data provider builds the graph. The graph builder may include rendering components. The graph visualizer may be universal graph visualizer component which can generate a graph constructed of nodes and edges in various graph layouts for an end user. The graph visualizer may include a display for visualizing or displaying the graph.

Defining a virtual structure for the data or a data view that differs from the native internal structure can be helpful for a user to understand the data. As illustrated in FIG. 2, a proxy engine 160 added into a system 102 before a data provider module 130 can dynamically transform a virtual query 112 representing a virtual structure of the data into a native query 114 that can be processed by the underlying data provider with a native internal structure. The proxy engine can be a proxy transformation engine that can transform the processed native result 124 with a native schema from the data provider into a virtual result 126 or virtual schema that represents the virtual structure of the data. The proxy engine can be a combination of a proxy processor, proxy memory, and proxy programming The proxy programming can be proxy instructions stored in proxy memory and the proxy instructions can run on the proxy processor. The proxy processor and memory may be the same as the processor and memory of the data provider application.

The proxy engine 160 may be a component responsible for transparent graph data transformation. The proxy engine may provide the same application programming interface (API) as the data provider and may translate query requests from the graph builder and translate data responses from the data provider. The virtual result or virtual schema may be used to generate a graph, referred to as a virtual graph 128, which can be displayed to a user. The proxy engine can use reusable or extensible transformation rules 170 that can transform the virtual query into the native query and native result with the native schema into the virtual result or virtual schema, respectively. The virtual query may be sent to the proxy engine from a graph visualizer 150 or graph builder 140. The graph builder may generate a virtual graph from the virtual result transformed by the proxy engine and the virtual graph may be displayed using a graph visualizer on a display device.

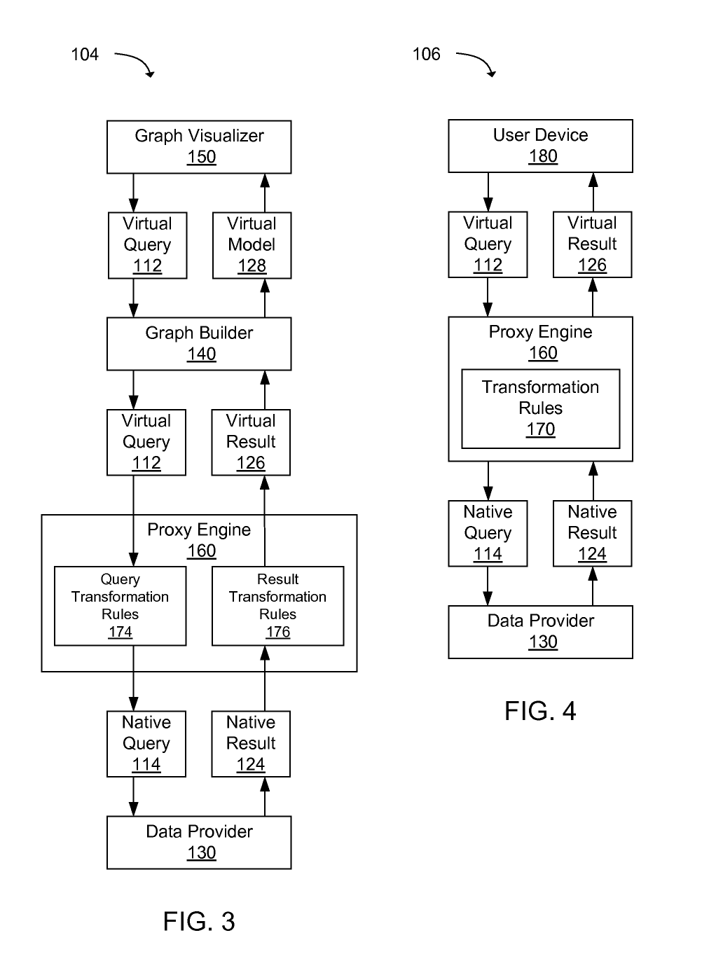

In another configuration, the proxy engine in a system 104 can have query transformation rules 174 that transform the virtual query into the native query and native result, as illustrated in FIG. 3. The proxy engine can have result transformation rules 176 that transform the native result or native schema into the virtual result or virtual schema. In an example of another system 106 illustrated in FIG. 4, a virtual query 112 may be generated from a user device 180, and the virtual result 126 and schema may be transformed by the proxy engine 160 may be returned to the user device.

A data provider or database can store entities and relations or nodes and edges. A node can be an entity, object, or item that may be tracked, such as a person, business, or account. An edge can be a line or relation that connects nodes or a node to a property. The edge can represent the relationship between nodes or entities. An entity may include an entityId, entityType, and properties. A relation can include data fields such as fromEntityId, toEntityId Id, and relationType. The data provider application may be a component that provides graph-structured data and meta information about the data. The data provider application may interface with a database to get entity information by ID, get related entities, or get metadata (supported entity and relation types). The data provider application may be a component of a database.

A query provided to a data provider can include entities, relationships, or properties, referred generally as entity-relation objects, or entity-relation object types. The query can be a data query or instance query associated with a relational database, or the query can be a schema query associated with a graph-structured database or a schema-driven query language. The entity-relation object type may define a class or type of entity, relationship, or property. A result or schema returned from a data provider can include entities, relationships, properties, entity-relation objects, and/or entity-relation object types.

A query can be a request made by a user or an instruction provided to a data provider to search and retrieve certain data in the data repository to return the data in a specified format. A result or schema can be the output of a data provider after processing the query. A result can provide the output in tables. A schema can provide the output in a graph or chart.

A native query can be a query that can be processed by the data provider using the native internal structure, entities, relations, and properties of the data repository without a proxy transformation. A native result or a native schema can be an output generated by the data provider using the native internal structure, entities, relations, and properties of the data repository without a proxy transformation. A virtual query can be a query that can be processed by the data provider with a transformation provided by a proxy engine where the virtual entities, virtual relations, and virtual properties of the virtual query are transformed into native entities, native relations, and native properties that can be processed by a data provider. A virtual result or a virtual schema can be an output generated by the data provider with a transformation provided by the proxy engine where native entities, native relations, and native properties are transformed into virtual entities, virtual relations, and virtual properties. The virtual entities, virtual relations, and virtual properties may not represent actual stored entities, relations, and properties in the data repository. The virtual entities, virtual relations, and virtual properties may differ from the native entities, native relations, and native properties. The virtual query may have more virtual entities and relationships than the corresponding native query has native entities and relationships. The native query may have more native entities and relationships than the corresponding virtual query has virtual entities and relationships.

The virtual result may have fewer entity-relation objects than the native result. The virtual result may have more entity-relation objects than the native result. A graph generated or built from a virtual result or virtual schema may have fewer entity-relation objects than a corresponding theoretical native graph that may have been built from the native result or native schema if a proxy engine did not transform the native result or native schema into a virtual result or virtual schema. A graph generated or built from a virtual result or virtual schema may have more entity-relation objects than a corresponding theoretical native graph that may have been built from the native result or native schema if a proxy engine did not transform the native result or native schema into a virtual result or virtual schema.

The virtual entity-relation object used in the virtual query and virtual result or virtual schema can be selected from a virtual data set that includes a plurality of predefined virtual entity types and a plurality of predefined virtual relation types setup previously by a user which may be associated with transformation rules. The native entity-relation objects used in native query and native result or virtual schema may be selected from a native data set. At least one virtual entity type or virtual relation type defined in the virtual data set may be not defined in the native data set. At least one native entity type or virtual relation type defined in the native data set may be not defined in the virtual data set. The virtual data set may be definable by a user and the native data set may be defined previously by a database administrator.

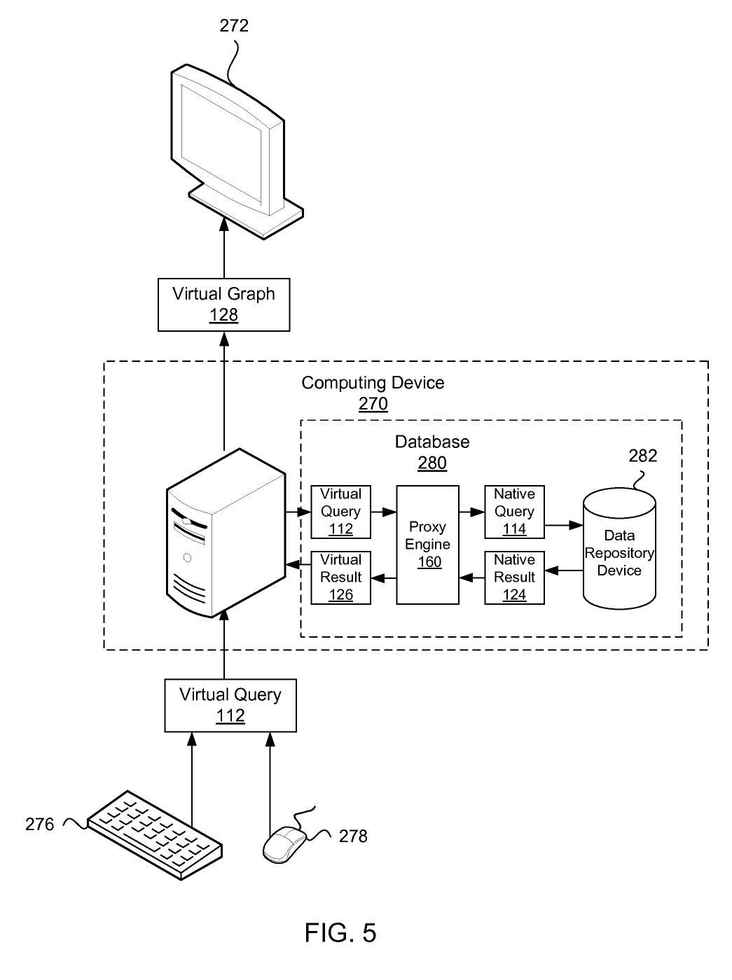

A system and method may be used for transforming entity and relation data using a proxy engine 160, as illustrated in FIG. 5. The virtual query may be generated using a computing device 270 for generating a query and displaying a virtual result, virtual schema, or virtual graph. The computing device can be a computer, a server, portable mobile device, wireless device, or other device for intercepting the virtual query 112, transforming the virtual query into the native query 114, processing the native query into the native result 124 or native schema, transforming the native result or native schema into the virtual result 126 or virtual schema, or displaying the virtual result, virtual schema, or virtual graph 128. The virtual result, virtual schema, or virtual graph generated by the proxy transformation process on the computing device may be displayed on a display 272, which can be coupled to the computing device. The computing device may build a virtual graph from the virtual result or virtual schema

A user may enter a virtual query 112 using an input device 276 or select a predefined query or create a query with a selection device 278. The input device may be a computer keyboard, voice recognition device, touch screen, selection device, or other similar device. The selection device may be a computer mouse, electronic pen, touch screen, or other similar device. The computing device 270 may include memory, a central processing unit (CPU), and a database 280. The database may include a data provider application on a data repository device 282 and a proxy engine 160. Memory may be RAM, flash drive, or other volatile or non-volatile medium for storing electronic data.

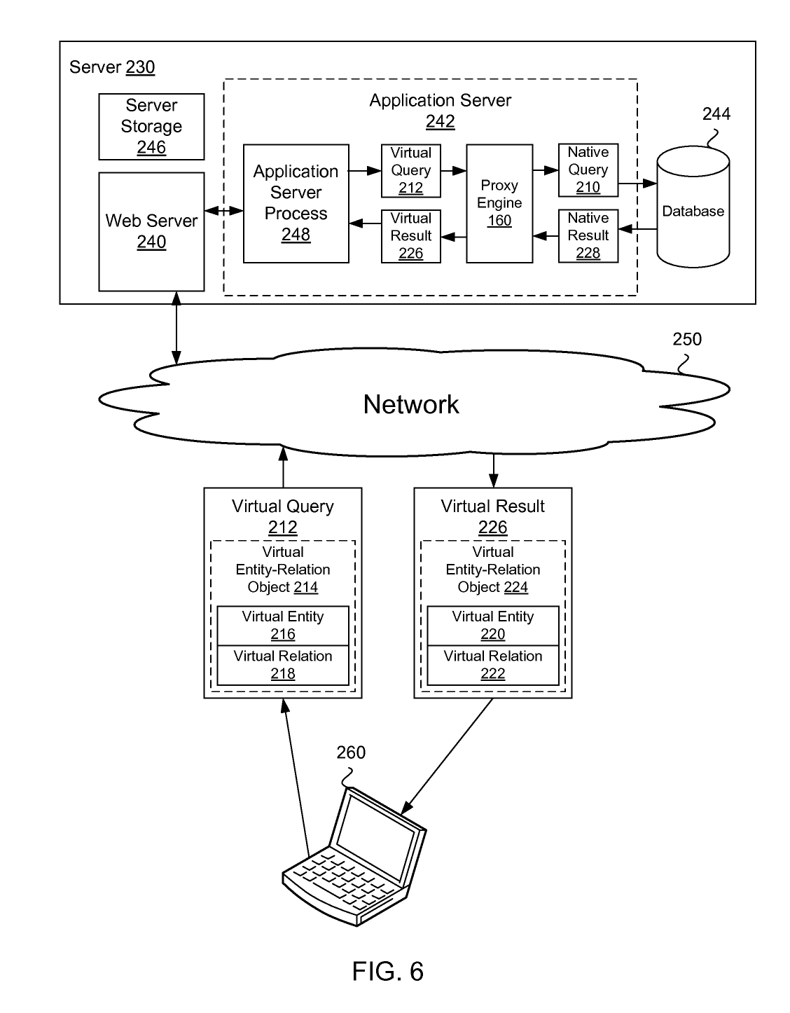

As illustrated in FIG. 6, the system for transforming entity and relation data using a proxy engine may be implemented using a server system. The server 230 can include a web server 240, an application server 242, a database 244, and server storage 246. The server storage can include a computer readable storage medium that can provide instructions for transforming entity and relation data using a proxy engine. The virtual query 212 which includes a virtual entity-relation object 214 may be generated by a browser or client application on a user device 260 and sent to a database of the server via a web server and application server process 248 on the application server through a network 250 or Internet. The virtual entity-relation object may include a virtual entity 216 or a virtual relation 218. The proxy module or proxy engine may be included with the application server or the database (FIG. 6 does not show the proxy engine associated with the database). The server may provide the intercepting of the virtual query 212, the transformation of the virtual query into the native query 210, the processing of the native query into the native result 228 or native schema, and the transformation of the native result or native schema into the virtual result 226 or virtual schema. The virtual result or virtual schema may be sent to the user device and the virtual result, virtual schema, or virtual graph may be displayed on the user device via browser or client application. The user device may include a graphing application that displays the virtual result or virtual schema as a graph or converts the virtual result or virtual schema into a graph then displays the graph. The graphing application may be located on the server or the database.

The proxy engine can intercept a query or virtual query directed to a data provider application on a data repository device. The proxy engine may distinguish arguments in a virtual query containing virtual entity-relation objects from a native query that contains native entity-relation objects. The virtual query may include a virtual entity-relation object not included in a set of available native entity-relation objects in which a subsequent native query is generated (from the transformation of the virtual query). The native query may include a native entity-relation object not included in a set of available virtual entity-relation objects from which the virtual query was generated. When a query includes any virtual entity-relation object that is not included in the native internal structure, the transformation rules may be applied to the query. When a query does not include a virtual entity-relation object the proxy engine may pass the query and allow the data provider to process the query as an untransformed, native query. Likewise, when a result or schema includes a virtual entity-relation object not included in the native internal structure, the transformation rules may be applied to the result or schema. When a result or schema does not include a virtual entity-relation object the proxy engine may pass the result or schema to the user device, graph visualizer, or graph builder as an untransformed, native result or schema.

Transformation rules processed by a proxy engine that can convert a virtual query into a native query may be referred to as a virtual-to-native rule set. The virtual-to-native rule set may include a virtual-to-native rule to change a virtual entity type to a native entity type (change a virtual change entity type to a native change entity type), change a virtual relation type to a native relation type (change a virtual change relation type to a native change relation type), add a native entity type (add a native add entity type), add a native relation type (add a native add relation type), or change a virtual entity-relation type combination to a native entity-relation type combination (change a virtual change entity-relation type combination to a native change entity-relation type combination). An entity-relation type combination may be a combination or configuration of entities and relations, which may include no entities or no relations (similar to rules for in deleting entities or relations). For example, a virtual entity-relation type combination may be entity A with a relation X to entity B and the transformation rule may transform the virtual entity-relation type combination into a native entity-relation type combination of just entity C.

Transformation rules processed by a proxy engine that convert a native result or native schema into a virtual result or virtual schema may be referred to as a native-to-virtual rule set. The native-to-virtual rule set may include a native-to-virtual rule to change a native entity type to a virtual entity type (change a native change entity type to a virtual change entity type), change a native relation type to a virtual relation type (change a native change relation type to a virtual change relation type), remove a native relation type (remove a native remove relation type), remove a native entity type (remove a native remove entity type), or change a native entity-relation type combination to a virtual entity-relation type combination (change a native change entity-relation type combination to a virtual change entity-relation type combination).

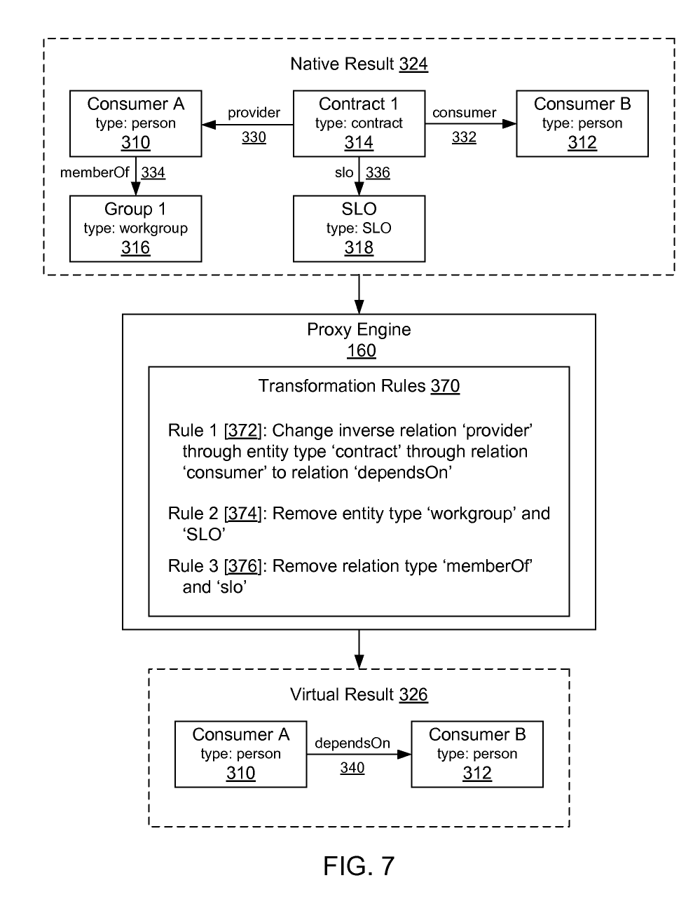

For example, the proxy engine 160 may have native-to-virtual transformation rules 370 to transform a native result 324 to a virtual result 326, as illustrated in FIG. 7. In this simplified example, a first rule 372 can be change inverse relation ‘provider’ through entity type ‘contract’ through relation ‘consumer’ to relation ‘dependsOn.’ A second rule 374 can be to remove entity type ‘workgroup’ and ‘SLO.’ A second rule may be a combined rule or two distinct rules: a rule to remove entity type ‘workgroup’ and a rule to remove entity type ‘SLO.’ A third rule 376 can be remove relation type ‘memberOf’ and ‘slo.’ A third rule may be a combined rule or two distinct rules: a rule to remove relation type ‘memberOf’ and a rule to remove relation type ‘slo.’

A native query result 324 may include the entities Consumer A 310 of type person, Contract 1 314 of type contract, Consumer B 312 of type person, and Group 1 316 of type workgroup, and SLO 318 of type slo. Contract 1 may have a relation provider 330 to Consumer A, a relation consumer 332 to Consumer B, and a relation slo 336 to SLO. Consumer A may have a relation memberOf 334 to Group 1. The native query result may be captured and processed by the proxy engine. The first transformation rule may change the entity-relation combination of ‘provider’ through entity type ‘contract’ through relation ‘consumer’ to relation ‘dependsOn’ 340 so relations provider and consumer are eliminated and entity Contract 1 is eliminated. The second transformation rule may remove or ignore entities SLO and Group 1. The third transformation rule may remove relations memberOf and slo resulting in a virtual result 325. Unused entities and relations may be automatically filtered out by the proxy engine.

Transformation rules may be used to add entity types or relation types that do not exist in the native data set. The transformation rules can describe the transformation of a graph meta model. Graph transformation can result in a different view of the graph data. Graph transformation can include hiding or replacing entities of a specific type, hiding or replacing relations of a specific type, and introducing new relations based on other entities and relations.

Often changes to a native internal database structure or changes to entity types and entity relations are performed by database administrators and a user may have little control over how the data is displayed or graphed. The method and system disclosed for transforming entity and relation data using a proxy engine can allow a user to define and form transformation rules to display data that may be more meaningful to a user. The transformation rules may be written either by database administrators or users. The rules may reused and the transformation can occur transparently to the user once the rules are setup. Rules in the virtual-to-native rule set may be generated automatically from the native-to-virtual rule set. Rules in the native-to-virtual rule set may be generated automatically from the virtual-to-native rule set. The transformation rules may change when the structure, entities, or relations of the underlying database change.

Multiple sets of rules may be applied to a specific data repository or database. The multiple sets of rules may be created and used by the proxy engine based on user type or view type. For example, a manager set of rules may be applied to a user if the user has a manager designation for a user type, and a technician set of rules may be applied to a user if the user has a technician designation for a user type. In another example, a marketing set of rules may be applied to a user if the user selects a marketing view type for the data, and an operations set of rules may be applied to the same user if the user selects an operations view type for the data. The proxy engine may apply a rule set for a user type or a view type based on the arguments in the query, user credentials, or some other indicator associated with the database or user. A user may be able to switch between view types and apply different transformation rules and different transformation rule sets in the proxy engine.

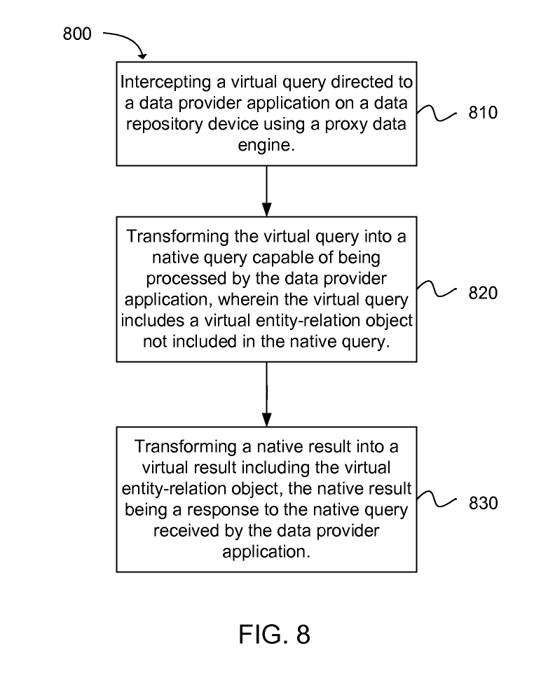

Another example provides a method 800 transforming entity and relation data using a proxy engine, as shown in the flow chart in FIG. 8. The method includes the operation of intercepting a virtual query directed to a data provider application on a data repository device using a proxy data engine, as in block 810. The operation of transforming the virtual query into a native query capable of being processed by the data provider application follows, wherein the virtual query includes a virtual entity-relation object not included in the native query, and the native query includes a native entity-relation object not included in the virtual query, as in block 820. The next operation of the method may be sending the native query to the data provider application for processing. The operation of receiving a native result of the native query from the data provider application by the proxy data engine may follow. The method further includes transforming a native result into a virtual result including the virtual entity-relation object, the native result being a response to the native query received by the data provider application, as in block 830.

The method and system can be efficient, scalable, reusable, extensible, and platform neutral. The method and system may be efficient because the proxy transformation can be fast, as the system does not generate and transfer unnecessary data when the proxy engine is located close to the data source or database. In addition, a larger native result or native schema (measured in bytes) may be replaced with a smaller virtual result or virtual schema and transmitted through a network. The method and system may be scalable because the transformation rules do not depend on the size of the graph. Transformed graphs can be generated from very large datasets using the proxy engine and transformation rules. The method and system may be reusable which can allow new graph views to be implemented quickly by defining new transformation rules. The method and system may be extensible because the proxy engine and transformation rules may be adjusted to different problems in different applications. The method and system may be platform neutral by providing a model which may not depend on a database type, a programming language, or the format of the data or graph store in the database.

The proxy engine and transformation rules can be applied to graph-structured data to allow an effective visualization of data without modifying the internal model of the system. The method and system can provide advantages over both graph rewriting and using a custom graph-builder module. Graph rewriting can use a native query and can transfer the entire native result post-processing to a user system or a display. The user system or display simplifies or rewrites the data based on a graphical simplification process. A custom graph-builder module may not be reusable, extensible, or capable of being defined by a user of the data.

The technology described here can also be stored on a computer readable storage medium that includes volatile and non-volatile (transitory and non-transitory), removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology. Computer readable storage media can include server storage and the instructions as installation file or files downloadable from that storage. Computer readable storage media can include a portable memory device for storing the installation files or files.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof It is understood that such embodiments, examples, and alternatives are not to be construed as defacto equivalents of one another, but are to be considered as separate and autonomous representations of the present invention.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts described. Accordingly, it is not intended that the invention be limited, except as by the claims set forth below.

What is claimed is:

1. A method for transforming entity and relation data using a proxy engine, comprising:
intercepting a virtual query directed to a data provider application on a data repository device using a proxy data engine;
transforming the virtual query into a native query capable of being processed by the data provider application, wherein the virtual query includes a virtual entity-relation object not included in the native query; and
transforming a native result into a virtual result including the virtual entity-relation object, the native result being a response to the native query received by the data provider application.

2. The method of claim 1, wherein the native query includes a native entity-relation object not included in the virtual query.

3. The method of claim 1, further comprising:
sending the virtual result to a display device; and
displaying the virtual result on the display device.

4. The method of claim 3, wherein displaying the virtual result further comprises:
building a virtual graph from the virtual result, wherein the virtual result includes a virtual schema; and
displaying the virtual graph where the virtual graph includes the virtual entity-relation object.

5. The method of claim 4, wherein the virtual graph changes a native graph generated from the native result by either reducing the number of entity-relation objects in the native result or adding the number of entity-relation objects in the native result.

6. The method of claim 1, wherein the virtual entity-relation object includes a virtual entity or a virtual relation and the native entity-relation object includes a native entity or a native relation.

7. The method of claim 1, further comprising processing the native query into the native result via the data provider application.

8. The method of claim 1, wherein the virtual result has fewer or more entity-relation objects than the native result, wherein an entity-relation object includes an entity or a relation.

9. The method of claim 1, wherein transforming the virtual query into a native query uses a virtual-to-native rule set including a virtual-to-native rule to change a virtual change entity type to a native change entity type, change a virtual change relation type to a native change relation type, add a native add entity type, add a native add relation type, or change a virtual change entity-relation type combination to a native change entity-relation type combination.

10. The method of claim 1, wherein transforming the native result into a virtual result uses a native-to-virtual rule set including a native-to-virtual rule to change a native change entity type to a virtual change entity type, change a native change relation type to a virtual change relation type, remove a native remove relation type, remove a native remove entity type, or change a native change entity-relation type combination to a virtual change entity-relation type combination.

11. The method of claim 1, wherein transforming the virtual query into a native query and transforming the native result into a virtual result uses rule sets based on a user type.

12. The method of claim 1, wherein transforming the virtual query into a native query and transforming the native result into a virtual result uses rule sets based on a view type.

13. The method of claim 1, wherein transforming the virtual query into a native query and transforming the native result into a virtual result uses rule sets definable by a user.

14. The method of claim 1, wherein the virtual entity-relation object for the virtual query is selected from a virtual data set including a plurality of virtual entity types and a plurality of virtual relation types, and the native entity-relation object for the native query is selected from a native data set including a plurality of native entity types and a plurality of native relation types, and at least one virtual entity type or virtual relation type defined in the virtual data set is not defined in the native data set.

15. The method of claim 14, wherein the virtual data set is definable by a user and the native data set is defined by a database administrator.

16. A system for transforming entity and relation data using a proxy engine, comprising:
a data provider application on a data repository device for processing a native query into a native result, wherein the data provider application includes a data provider processor, data provider memory, and data provider programming; and
a proxy engine operable with the data provider application for transforming a virtual query into a native query and transforming a native result into a virtual result,
wherein the proxy engine includes a proxy processor, proxy memory, and proxy programming,
wherein the virtual query includes a virtual entity-relation object not included in the native query, and
wherein the virtual result includes a virtual entity-relation object not included in the native result.

17. The system of claim 16, further comprising:
a user device in communication with the data repository device for sending the virtual query and receiving the virtual result; and
a display coupled to the user device for displaying the virtual result.

18. The system of claim 16, further comprising:
a graphing application on the user device wherein graphing application converts the virtual result into a graph; and
a display coupled to the user device for displaying the graph of the virtual result.

19. The system of claim 16, further comprising:
a graphing application on the data repository device wherein graphing application converts the virtual result into a graph, wherein the user device receives the graph; and
a display coupled to the user device for displaying the graph of the virtual result.

20. A computer readable storage medium having computer readable instructions to perform operations comprising:
intercepting a virtual query directed to a data provider application on a data repository device using a proxy data engine;
transforming the virtual query into a native query capable of being processed by the data provider application, wherein the virtual query includes a virtual entity-relation object not included in the native query;
sending the native query to the data provider application for processing;
receiving a native result of the native query from the data provider application by the proxy data engine;
transforming the native result into a virtual result including the virtual entity-relation object;
building a virtual graph from the virtual result; and
displaying the virtual graph where the virtual graph includes the virtual entity and the virtual relation.
